(19) United States
(12) Patent Application Publication
(10) Pub. No.: US 2009/0071828 A1
(43) Pub. Date: Mar. 19, 2009

(54) Devices Exhibiting Differential Resistance to Flow and Methods of Their Use

(76) Inventors: Todd M. Squires, Goleta, CA (US); Max Narovlyansky, Cambridge, MA (US)

Correspondence Address: CLARK & ELBING LLP, 101 FEDERAL STREET, BOSTON, MA, 02110, US

(21) Appl. No.: 11/886,361

(22) PCT Filed: Mar. 23, 2006
(86) PCT No.: PCT/US06/10605

§ 371 Date: Nov. 3, 2008

Related U.S. Application Data
(60) Provisional application No. 60/664,766, filed on Mar. 23, 2005.

(51) Int. Cl. G01N 27/447

(52) U.S. Cl. 204/453; 204/604

(57) ABSTRACT

The invention features microfluidic devices that contain structures that impart differential resistance to a fluid flow. The structures are disposed adjacent to intersections of channels. Devices of the invention provide differential resistance, e.g., under electric-field-driven flow and pressure-driven flow.

### BACKGROUND OF THE INVENTION

The invention relates to field of microfluidics.

Microfluidic devices driven by electrical fields hold considerable potential for separation of complex mixtures. Minimizing injection volumes decreases the length of time required for separation, decreases the size of the separation device, and increases separation resolution. Improvements in minimizing injection size can therefore lead to improvements in microanalytical devices. For separations, electroosmotic flow usually gives better separation than pressure-induced flow, and it is easier to implement. Because flow fields typically scale linearly with the local electric field, microfluidic devices are well suited for modular design required for implementation of multiple fluidic tasks on a single two-dimensional platform.

Established electrokinetic sample introduction methods rely on open channel geometries like double-T and double-L methods to define the injection zone or upon isoelectric focusing (IEF), also called pinched injection. These methods use a two-step injection, where sample is initially drawn from a sample reservoir and then introduced into another channel in a second step to give a discrete sample plug. The double-T and -L injections result in injection of sample plugs of greater axial extent than the width of the sample introduction channel. In IEF injection, the sample is isoelectrically confined to control the initial distribution of the analyte in an open intersection, giving sharp bands. While the focusing potentials reduce the injected sample volume, they pinch the sample with electroosmotic flows from two arms of a separation channel. Thus, IEF confinement of initial sample distribution results in an undesirable asymmetry and sample loss with respect to a rectangular injection zone defined by an entire intersection. Moreover, the extent of focusing needs to be controlled through the focusing potentials applied orthogonal to the sample introduction channel. Underfocusing leads to sample leaking into the separation channel, while overfocusing leads to additional sample loss and a more asymmetrical injection zone. This problem has been addressed by using a double-cross electrokinetic focusing injection microfluidic device, which allows introduction of narrower bands focused in one cross, and injected in the other. This method allows electrokinetic delivery of sample plugs of variable volume and with a better profile, but requires additional channels and sample ports as well as an additional power supply.

### SUMMARY OF THE INVENTION

The invention features microfluidic devices that contain structures that impart differential resistance to a fluid flow. Differential resistance may be generated parallel, e.g., along the length of a channel, or perpendicular to the length of a channel, to the direction of flow in a channel. Devices of the invention provide differential resistance, e.g., under electric-field-driven flow and pressure-driven flow.

In one aspect, the invention features a microfluidic device capable of introducing plugs of sample with low dispersion and methods of its use. In general, the device includes two intersecting channels, where at least one channel contains one or more structures that cause anisotropy to flow, e.g., under an electric field, e.g., by reducing the electrical permeability of the channel adjacent the intersection.

Accordingly, the invention features a microfluidic device including a first channel; a second channel that includes a first structure that causes anisotropic flow, e.g., under an applied electric field or a pressure gradient; and an intersection of the first and second channels, wherein the structure is disposed adjacent the intersection. The device may further include a second structure adjacent the intersection that causes anisotropic flow, wherein the intersection bifurcates the first and second channels, and the first and second structures are disposed on opposite sides of the intersection. In additional embodiments, the device further includes third and fourth structures adjacent the intersection, wherein the third and fourth structures cause anisotropic flow and are disposed on opposite sides of the intersection and in the first channel. Structures in the device may cause anisotropy by lowering the permeability, e.g., to electric fields or pressure gradients, of at least a portion of the channel in which they are disposed. An exemplary structure divides the channel into a plurality of subchannels. Another example of a structure includes a porous matrix, e.g., a gel. Exemplary gels may exhibit reverse thermal gelation and/or be biocompatible. Gels may also include components, such as a cell, virus, enzyme, or drug candidate, immobilized or otherwise localized therein.

The device may further include additional channels capable of producing sheath flow adjacent to the first structure, e.g., that are capable of introducing fluid into the first channel upstream of the intersection.

The device may also include a voltage source capable of generating a voltage gradient spanning the intersection and aligned, e.g., along the first or second channel, or a device capable of generating a pressure gradient.

In certain embodiments, the structure is passive, i.e., no external actuation, other than an electric field or pressure gradient to induce fluid flow, is required to create anisotropy. In certain further embodiments, the structure is not a valve capable of completely occluding a channel.

The invention further features a method for introducing a sample in a microfluidic channel using a device, as described above including pumping the sample via the first channel into the intersection, e.g., via an electric field or pressure gradient; and introducing the sample into the second channel, e.g., in a plug having substantially the shape of the intersection. This method may further include allowing separation of at least two components in the sample introduced into the second channel or analyzing, reacting, concentrating, or isolating at least a portion of the sample. The method may be repeated to introduce a plurality of plugs of sample into the second channel, e.g., at a rate of at least 1, 10, 100, 1,000, or 10,000 Hz. When the device further includes a third channel that forms a second intersection with the second channel and that includes a structure that causes anisotropic flow, e.g., under an applied electric field, the method may further include pumping at least a portion of the sample introduced into the second channel into the second intersection; and introducing at least a portion of the sample into the third channel. Such a method may be used to perform two manipulations, that are the same or different, on the sample, or portions thereof, in the second and third channels. When a gel is employed, the gel may include a localized component, such as a cell, virus, enzyme, or drug candidate. In such embodiments, the method may further include assaying the sample for interaction with the component.

The invention also features a method of forming a gel in a microfluidic device by a. providing a microfluidic device of the invention including a channel having a structure that divides a portion of said channel into subchannels; introducing a liquid capable of gelling into the channel, wherein the liquid flows through the channel by capillary action to fill the subchannels substantially; and allowing or causing the liquid to gel. Such gels may include components as described herein.

The invention also features a microfluidic device having a structure therein that introduces a differential resistance to pressure-driven flow.

In this aspect, the invention features a microfluidic device including a channel having a structure, wherein the channel has a first resistance to pressure-driven flow in the absence of the structure, and the structure has a second resistance to pressure-driven flow that is higher than the first resistance. Desirably, the structure and the channel have substantially the same resistance to electric-field-driven flow. The structure, for example, includes a channel that is shorter, e.g., at most 10%, and wider than the first channel in the absence of the structure. This device may be employed in a method of manipulating fluids in a microfluidic device under applied electric fields, such that pressure-driven flow is substantially dampened.

Exemplary materials for fabricating devices of the invention include PDMS, glass, and silicon. Furthermore, the invention features a combined device including a structure that causes anisotropic flow and a differential resistance structure, as described herein.

By “microfluidic” is meant having at least one dimension (e.g., length, height, width, or diameter) of less than 1 mm.

### BRIEF DESCRIPTION OF THE DRAWINGS

FIG. 1a is a micrograph of electrokinetic injection of fluorescein dye from a 50 μm injection channel across a 250 μm separation channel resulting in significant sample leakage and a mushroom-shaped plug whose width scales roughly with the separation channel width. This leakage can be understood from the simulated electric fields shown in FIG. 1b, which clearly spread into the separation channel. FIG. 1c is a simulation of the field lines in which microfabricated partitions constrain almost all field lines to the intersection. FIG. 1d is a micrograph of partitioned electrokinetic injection, with sample largely constrained to the rectangular intersection. FIG. 1e is a micrograph of sample leakage occurring during longer injections because some field lines do traverse the partitions. FIG. 1f is a simulation of field lines showing leakage.

FIGS. 2a-2b are images of an exemplary structure that introduces anisotropic flow under an applied electric field.

FIGS. 2c-2d are images of an injection showing distribution of fluorescein among different intersections. Channel widths were 150 μm. The concentration of fluorescein was 500 μM in 30 mM sodium tetraborate buffer. In an intersection having a structure as described herein (a), a single electrical potential was applied between sample (S) and sample waste (SW) reservoirs, while buffer (B) and buffer waste (BW) reservoirs were floated. In (b) isoelectric focusing potentials were applied to B and BW, which lead to electrokinetic focusing of the fluorescein stream. Light from a mercury lamp was filtered with a 500 nm shortpass optical filter. A color CCD camera collected fluorescence light focused through a 10× at a right angle relative to the excitation light.

FIG. 3a is an image of a device that includes a structure that introduces a differential resistance to electric-field driven flow. FIG. 3b is an image showing injection and separation of a sample plug in the device of FIG. 3a.

FIG. 4a is a FEMlab simulation of the field lines in a device employing sheath flow and partitions to shape a plug of fluid. FIG. 4b is a schematic depiction of a device that employs sheath flow. FIG. 4c is a micrograph of an injection of fluid using sheath flow and partitions. FIG. 4d is a FEMlab simulation of the field lines in a device employing sheath flow without partitions in the intersecting channel. FIG. 4e is a micrograph of an injection of fluid using sheath flow without partitions in the intersecting channel.

FIGS. 5a-5c are a series of micrographs showing the separation of an equimolar (100 μm) mixture of fluorescein and 5′carboxy-fluorescein in 30 mM, pH 8.9 TRIS buffer. FIG. 5d is a micrograph showing repetitive injections of samples by employing pull-back potentials of 50 ms duration at 2 Hz.

FIGS. 6a-6d are a series of schematic depictions of laminar flow based (a and b) and capillarity based introduction of gels into a channel (c and d). The darker regions indicate channel portions without gel. FIGS. 6e-6f are schematic illustrations of laminar flow based introduction of gels.

FIGS. 7a-7e are a series of schematic depictions of capillarity based introduction of gels into a channel. Filling a channel is shown in a-c; d illustrates how partitions prevent gel from filling intersecting channels; and e illustrates how constrictions prevent gel from filling intersecting channels.

FIG. 8 is a fluorescence image of the separation of fluorescein (500 μM) and carboxy-fluorescein (500 μM) in sodium phosphate buffer (30 mM, pH 8.9).

FIGS. 9a-9e are schematic diagrams of a method of manipulating a sample using a device of the invention.

FIG. 10 is a schematic diagram of a device that includes a structure that introduces a differential resistance to pressure-driven flow.

### DETAILED DESCRIPTION OF THE INVENTION

The invention provides devices that include structures that exhibit differential resistance to flow, e.g., under electric-field-driven flow or pressure-driven flow. Such devices allow for the miniaturization of sample distortion and the dampening of pressure-driven flow. In addition, the devices may also be employed for filtration of particulate samples or controlled contacting of reagents with other compounds, cells, or viruses.

### Anisotropic Resistance to Flow

Electric Field. In this embodiment, the invention provides a microfluidic device capable of shaping an applied electrical field such that a plug of sample, i.e., a volume of fluid in a channel, can be introduced into an intersecting channel with low dispersion. The devices include a structure that produces anisotropic flow under an applied electric field. For example, the structure allows for greater flow parallel to the electric field than orthogonal to the electric field. Although illustrated with channels intersecting at 90° angles, the invention is applicable to other angles of intersection.

Under typical conditions, the Debye layer thickness in an aqueous buffer is only a few nanometers—much narrower than the width of a typical microfluidic channel, e.g., tens of microns. Outside the Debye layer, fluid achieves a steady flow independent of channel width or geometry, given by the Smoluchowski velocity:

$$u = - \frac{{ɛɛ}_{0} ζ E}{η} \qquad ( 1 E )$$

which describes a uniform flow profile, characterized by velocity u(m/s), as a function of local electric field E(V/m), dynamic viscosity η(Pa·s), permittivity ε(F/m) and ε₀, and zeta potential ζ(V). Outside the Debye layer, the flow is uniform and insensitive to geometry, with minimal sample dispersion. The flow field is described by equation (1E) describing the similitude of flow velocity and electrical fields throughout the entire channel, but the electric field varies to maintain conservation of charge. The electrophoretic contribution to transport of analytes is likewise proportional to the local strength of the electric field. Because electrophoretic and electroosmotic mobility of any fluid element are linearly dependent on the electric field, which is locally nearly one-dimensional for the typical aspect ratio of microfluidic channels, there is no contribution to sample dispersion outside the Debye screening layer.

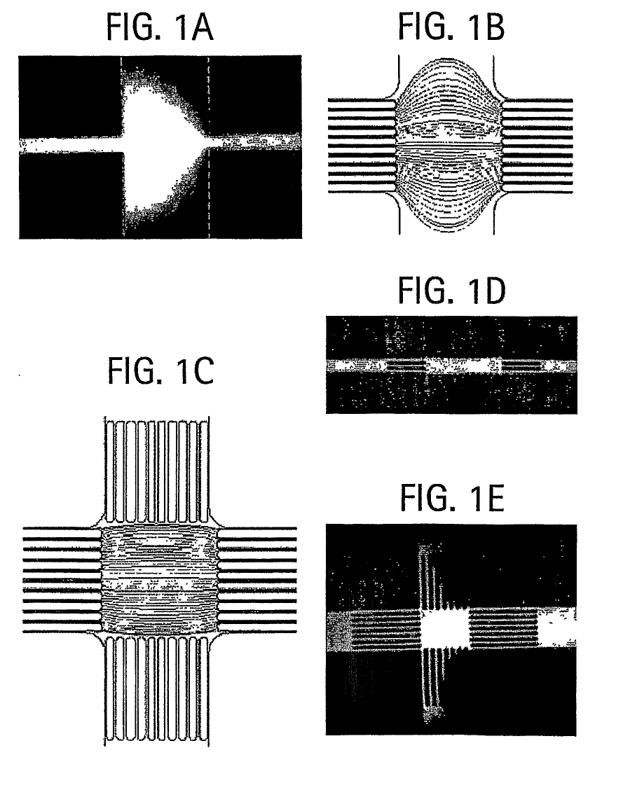

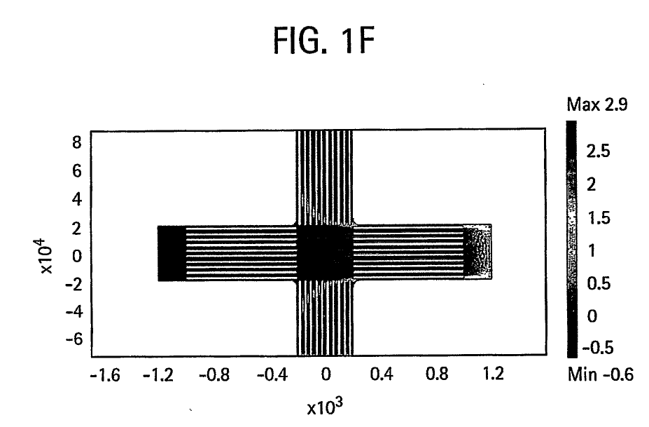

We have developed devices based on this principle to introduce differential resistance, i.e., anisotropy, without additional dispersion in an injected sample. We modeled the effect of this strategy when the flow approaches ideal electrokinetic conditions, and the velocity field can be computed directly from the Laplace equation without the need to solve the continuity and momentum equations, FIG. 1. The conditions for ideal electrokinetic flow include the absence of pressure difference, a steady electric field, uniform fluid properties, insulating, and impermeable channel walls, and electric Debye layer is thin compared to any physical dimension. The final requirement is that fluid velocities at all inlet and outlet boundaries satisfy the Helmholtz-Smoluchowski relation normally applicable to fluid-solid boundaries. For these conditions, the velocity flow field of the fluid is everywhere proportional to the electric field, a condition called “similitude” such that the coefficient of proportionality between electric and flow fields, given by the mobility μ(m²/V/s), is constant everywhere.

Under conditions of similitude, electric field lines also describe fluid flow, and the fluid flow is called potential flow. Potential flow is uniform and plug-like across the cross-section of the channel regardless of its geometry. This enabled us to model fluid flow using a 2D computer simulation of the electric field lines in a homogeneous medium. FIGS. 1b-1c compare the electric field lines in an open intersection (FIG. 1b) and that of a structure partitioning the channel into a series of subchannels (FIG. 1c). This simulation, carried out in FEMlab software (COMSOL), demonstrates how structures disposed adjacent an intersection can be used to constrain the electric field lines.

Some field lines do escape confinement (FIG. 1f), allowing minor sample leakage (FIG. 1e). Simple estimates can be performed for a large number N of partitions, each of width p and separated by q, whose length L is assumed to be greater than the channel width w. In this limit, the leakage field strength in the ith inter-partition space is approximately

$${E}_{i} \sim \frac{w - 2 ( i - 1 ) ( p + q )}{2 L} {E}_{∞} ,$$

and the strongest leakage field Eᵢ/E_{∞}˜w/2 L occurs within the first partition, where E_{∞} is the electric field in the open channels. The total fraction of the injection channel whose field lines ‘leak’ through the partitions on either side can be estimated to be Δw/w˜Nq/8 L. Because leakage fields Eᵢ are weaker than confined fields E_{∞} leakage is slower than injection, and rapid injections can reduce leakage (FIG. 1d).

The reduced cross-section of the subchannels near the intersection under conditions of potential flow leads to increased field strength and Joule heating within the constricted regions. The current across any axial cross-section must remain constant because of conservation of charge. Because the walls in partitioned channels are impermeable to the flow of charge, the electrical permeability of the channel segment to the electrical field depends on the volume fraction excluded. Neglecting surface conductance effects, the conductivity of the channel scales with the cross-sectional area of the channel.

I=σE=αSE=const (2E)

Where I is the current (C/s), σ is the conductivity (C·m/s/V) and α is the conductance (C/m/s/V). The electric fields strength in the occluded segment of the channel can be related to the field strength in the open channel.

E_{lined}=EₒₚₑₙSₒₚₑₙ/S_{lined} (3E)

PDMS walls within a “lined” channel segment occlude roughly 70% volume of the channel. Joule heating is given by power dissipation P=IE, where I(C/s) is the current. Under these circumstances the power dissipation in the constricted region is about three times greater than in the open channel segment.

We demonstrate a method of locally modulating the effective electric permeability of channels to electric fields to make well-defined plugs. This method is easy to implement, because it is largely independent of scale and material (assuming homogeneity) and requires only minor design alterations of the structure of the channels near an intersection. Under certain embodiment, no pull-back potentials are required to separate the injected plug from the sample stream, so sample injection cycle may be accelerated. In other embodiments, pull-back potentials (e.g., of 50 ms duration) may be employed to limit leakage into the partitions under steady state. Repetitive injection rates in excess of 10 Hz are possible. Only a single potential need be applied in the separation channel, while the other two electrodes may be floated. Reduced requirement for precise control of multiple potentials makes the method easier to use than IEF injection. The sample zones geometrically defined within channel intersection are sharp and symmetric and have more sample than IEF injection of the same resolution.

Pressure. The flow Q through a channel of uniform rectangular cross-section driven by pressure difference ΔP is given by

$$Q = Δ P \frac{{wh}^{3}}{12 μ L} \qquad ( 1 P )$$

where w, h, and L are the channel width, height, and length (for the approximation above, we require, w>>h), and g is the dynamic viscosity of the liquid (μ=1 cPoise for water). In general, the smallest dimension of the channel determines the resistance to pressure-driven flow. Constricting the width of a channel, or preferably, introducing partitions, reduces pressure-driven flow, as long as (sub)channel width can be reduced to less than the height. Given w>>h, the difference in resistance to pressure driven flow through a local constriction of the width of a channel or introduction of partitions is modest. The anisotropic permeability effects for pressure driven flow can be amplified by introducing a gel.

Capillarity. The devices of the invention also result in a resistance to capillary flow. For example, partitions change the capillary number of the channel, Ca, given by

$$Ca = \frac{μ {U}_{0}}{γ} \qquad ( 6 )$$

where γ is the surface tension. Capillary stresses of magnitude γ/R balance viscous stresses μU₀/h. Reducing the width of the channel or introducing partitions, leads to favorable capillary-driven flow into smaller channels. Capillary flow terminates after the partitions, providing a defined border.

Valving. Differential resistance to flow may also occur through the use of valves. Valves, e.g., torque actuated valves (Weibel et al. Anal. Chem. 2005 77:4726), can be integrated into a microfluidic device to prevent fluid flow in a desired channel. By positioning valves near an intersection, a defined plug of fluid may be introduced into an intersecting channel.

Device. In its simplest embodiment, a microfluidic device exhibiting anisotropy to flow, e.g., under an applied electric field, includes two, intersecting channels with at least one structure disposed adjacent the intersection. The structure introduces the anisotropy, e.g., by reducing the electrical permeability of the portion of the channel in which it is disposed. Typically, the two channels will bifurcate at the intersection. In such a configuration, each portion of a channel adjacent the intersection may contain a structure that introduces anisotropy, e.g., by lowering the electrical permeability. The structure may be of any suitable design, e.g., one capable of lowering the electrical permeability, desirably while allowing a plug of fluid to traverse the structure in the parallel direction with minimal distortion.

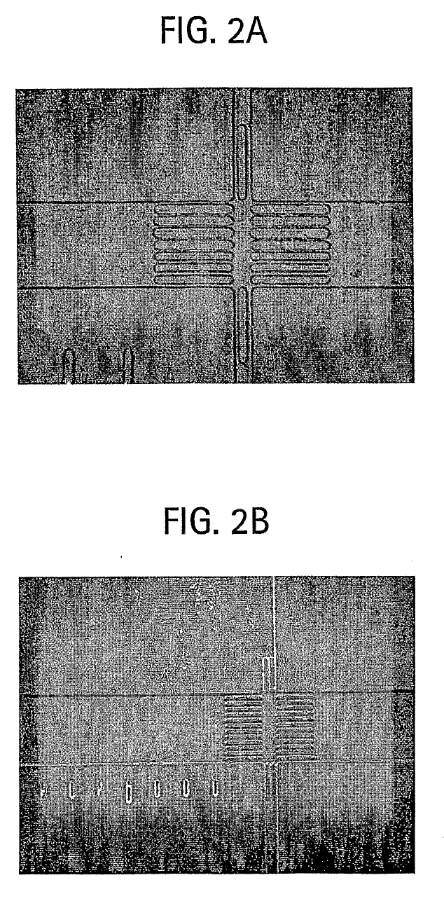

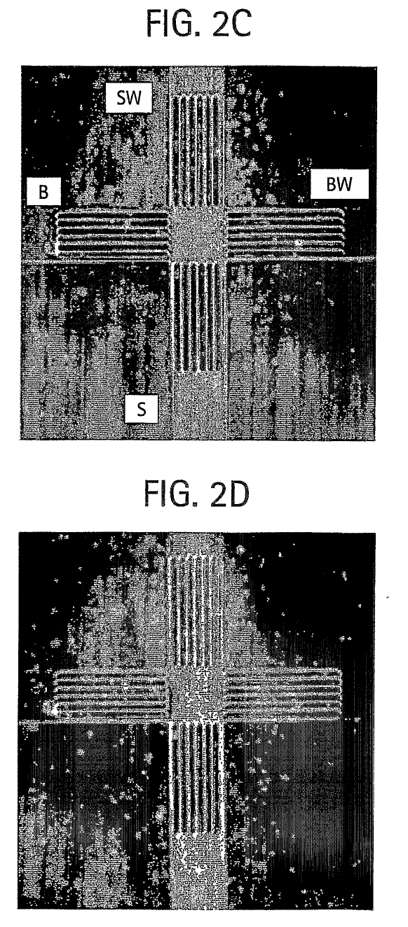

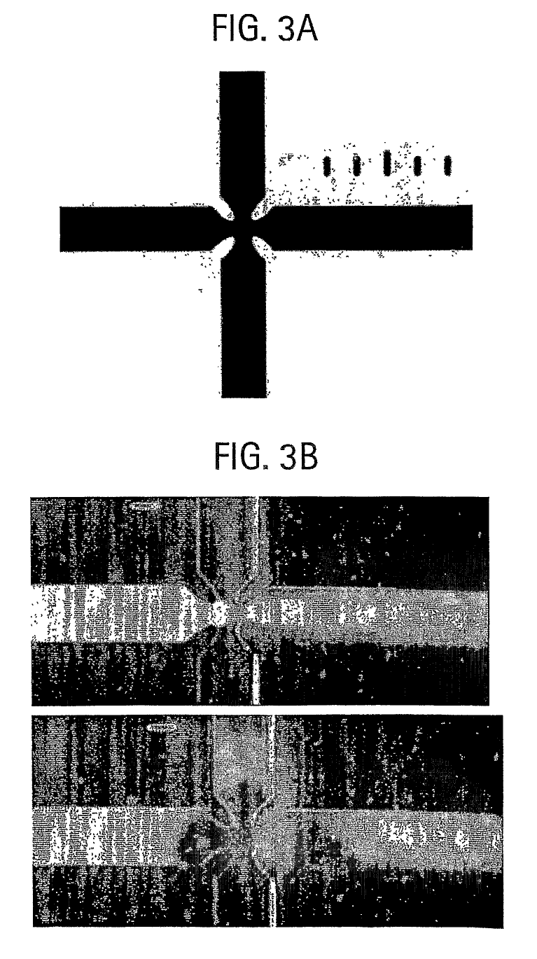

The exact design of the structure is not critical so long as it is capable of introducing anisotropy to flow, e.g., under an applied electric field, in the portion of the channel in which it is disposed. In one embodiment for anisotropy under an applied electric field, a structure of the invention need only prevent current flow through itself, i.e., be electrically insulating, in order to lower the permeability and thus introduce anisotropy. One method of accomplishing this end is to place obstacles fabricated out of an electrically insulating material within the channel. In one embodiment, the structure creates essentially a series of subchannels (FIG. 2a-2b). In general, as the width of the subchannels is decreased, e.g., at most 50, 40, 30, 20, 10, 5, or 1 μm, the amount of distortion in a sample plug is reduced. The series of subchannels may be achieved, e.g., by a series of posts or dividing walls, e.g., having widths of at least 5, 10, 20, 30, 40, 50, 75, or 100 μm. The width of posts or dividing walls may also be expressed as a percentage of the overall channel width, e.g., at least 1, 5, 10, or 20%. At least one dimension of channels in a device of the invention may be at least 10, 20, 50, 75, 100, 250, 500, 750, or even 1000 μm. Parameters that affect the permeability of a series of subchannels include the spacing, the amount of free volume, and the electric field strength. In general, decreasing the spacing and free volume decreases the permeability, while increasing the electric field strength increases the permeability. In an alternative embodiment, channel width is constricted at the intersection as shown in FIG. 3a to lower permeability. A porous media, such as an organic polymer, gel, or inorganic matrix, may also be disposed in a channel to lower the permeability.

In one embodiment, the structure is a series of walls that divide a portion of a channel into a series of parallel subchannels, which decrease the electrical permeability of the channel to (transverse) electrical fields and, by similitude of electrical and flow fields, confine a plug of sample. These regions of reduced permeability are disposed adjacent to the intersection, e.g., FIG. 2a, and define the shape of the injected sample plug. The width of the channel from which sample is introduced can be made several-fold narrower than the width of the channel into which the sample is introduced. Such an arrangement permits introduction of sample plugs of relatively short axial extent and, for example, can significantly improve the resolution of a separation.

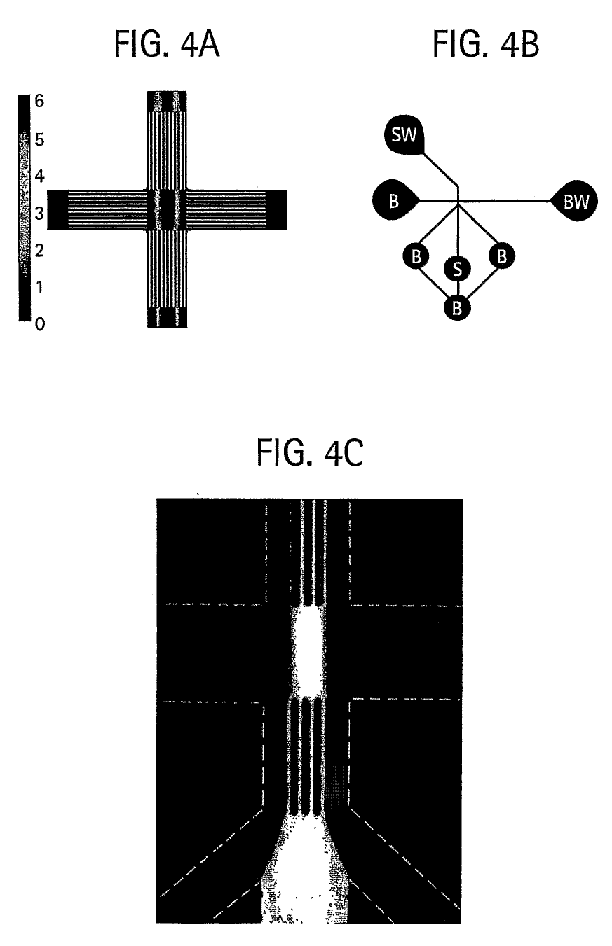

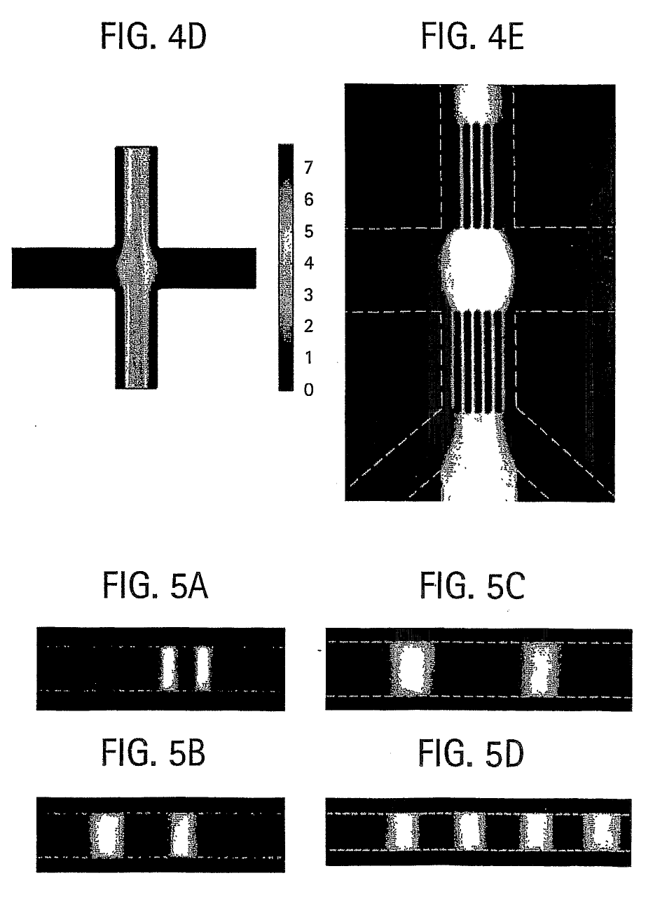

As described above, a series of finite partitions allows some leakage of current, and sample, under steady-state conditions. To achieve steady-state confinement, a sheath flow can be used to constrain injected analyte to field lines that remain confined, either by directly controlling the sheath potentials or by varying the relative lengths of the analyte and sheath channels (FIG. 4b). Simulations and experiments confirm the efficacy of these approaches (FIGS. 4a and 4c). FIGS. 4d and 4e illustrate that sheath flow alone, i.e., without partitions in the intersecting channel, is insufficient to prevent distortion of the fluid in the intersection. Partitioned injections in devices employing sheath flow are quite simple relative to other injection techniques, as only brief pull-back potentials are required during dispensation and separation. FIGS. 5a-c demonstrate the rapid separations that can be performed, and FIG. 5d demonstrates repetitive injections made possible by brief pullback potentials.

In addition to partitions, devices may of the invention may also, or in the alternative, include a gel or other porous medium in the structure. Matrices such as agarose (melting point can vary from 30-70° C.), or poly-N-isopropylacrylamide (PiPAAM) (low temperature gelling matrix) are suitable for this purpose. Gelation processes may be reversible or irreversible with temperature, and Joule heating may be used to melt, e.g., agarose, or to gel, e.g., in reverse thermal gelation, in a particular channel. Electrophoresis of ions through the matrix dissipates thermally according to

P=IV (2P)

where P is the power dissipation, and I and V are the current and the drop in electric potential across the channel. Typically, currents of 100 μA at voltages of ca. 200V/cm produce heat dissipation of 20 mW/cm, which is sufficient to melt high-melting agarose rapidly. This heating may also be used to produce a gel that is impermeable to pressure-driven flow. Other temperature control mechanisms may also be employed.

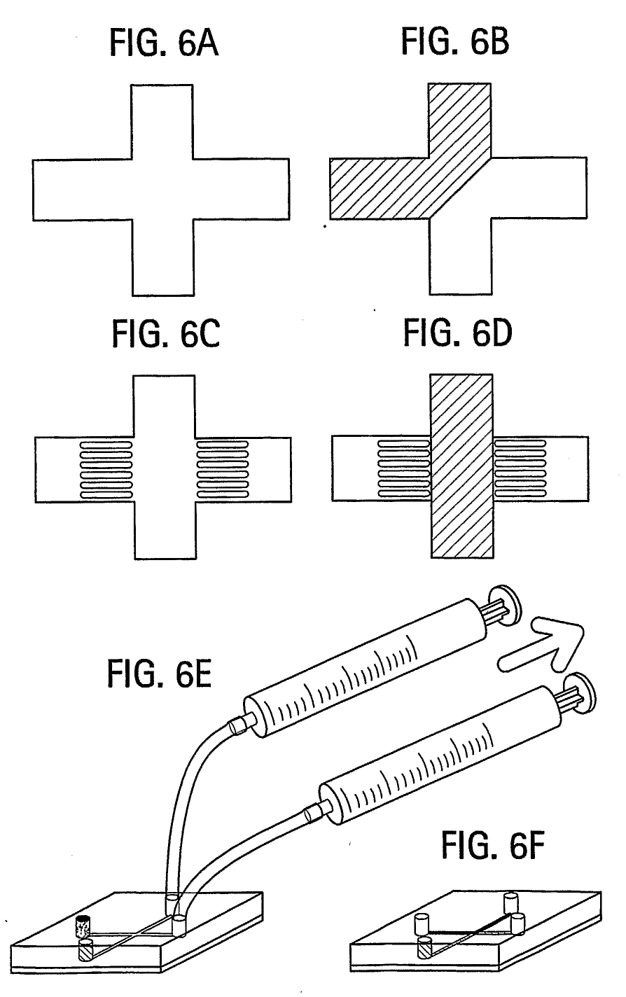

The solutions of pre-gel and buffer can be introduced by pressure driven flow, e.g., from a syringe pump or applied vacuum. Laminar flow volume fraction typically depends on viscosity of both components via Darcy's law:

$$\frac{{w}_{1}}{{w}_{2}} = \frac{{Q}_{1} {μ}_{1}}{{Q}_{2} {μ}_{2}} \qquad ( 3 P )$$

where w₁ and w₂ are the widths occupied by each of the flowing liquids, and μ₁ and μ₂ are the corresponding viscosities. Using volumetric control, Q₁=Q₂, gives relative width of occupancy of the two liquids at an open intersection in FIG. 6a, as determined by the relative viscosities of the two solutions

$$\frac{{w}_{1}}{{w}_{2}} = \frac{{μ}_{1}}{{μ}_{2}} \qquad ( 4 P )$$

When outlets are open to atmospheric pressure, the pressure-driven flow induced by Δh=1 mm difference in heights of liquid columns in the sample reservoirs is

ΔP=ρgΔh=10 Pa≈0.1 torr

where ρ is the liquid density. This pressure is an order of magnitude smaller than what is typically produced by a house vacuum (10⁻² torr, while a typical roughing vacuum achieving a pressure of 10⁻³ torr). So, using vacuum suction to drive pressure-driven flow, gives ΔP=const, and

$${Q}_{i} {μ}_{i} = \frac{Δ P}{{L}_{i}} \frac{{wh}^{3}}{12} \\ \frac{{Q}_{1} {μ}_{1}}{{Q}_{2} {μ}_{2}} = \frac{{L}_{1}}{{L}_{2}} \qquad ( 5 P )$$

where L₁ and L₂ are the lengths of the channels where the two respective phases are flowing, from the vacuum source to the sample inlets. Because each flow depends inversely on its own viscosity, the relative width occupied by each flow at an interface scales with the relative length of the corresponding channels.

In one method of filling a channel with a gel, North and East channels of an intersection of two open channels, FIG. 6a, are connected to a vacuum while the butter and gel solution are supplied at the West and South sample reservoirs. Application of vacuum establishes a buffer-gel interface, as schematically shown in FIG. 6b. The scheme shown in FIGS. 6a-6b relies on laminar pressure-driven flow. For thermogels, the required heating or cooling is maintained to control the onset of gelation. An alternative method of filling channels with a gel is illustrated in FIGS. 6c-6d. In this method, the location of the water-gel interface can be easily achieved using partitions within a channel, e.g., through capillary-based mechanisms described herein. In this scheme, a gel is introduced in the East and West channels, and only fills up through the partitions flanking the North and South channels. FIGS. 6E and 6F show schematically how laminar flow may be employed to localize gel formation into two of the four channels depicted. Other suitable gels and methods for their introduction in channels are known in the art. Methods employing partitions may result in more regular boundaries between gelled and un-gelled regions.

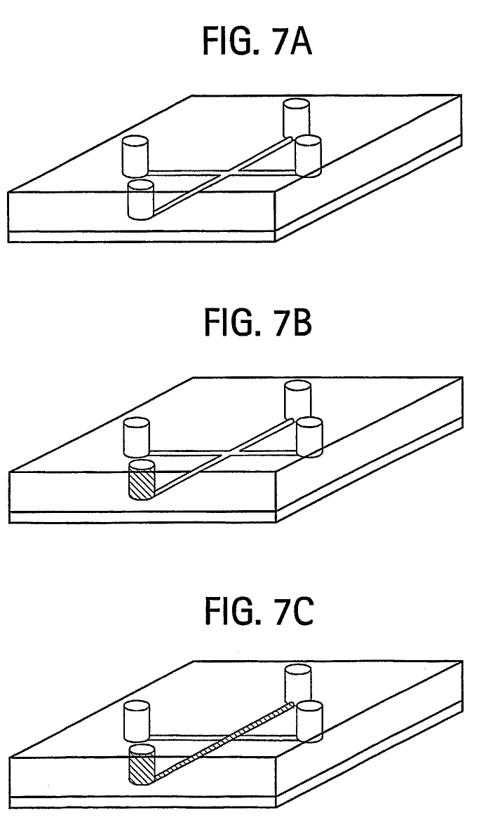

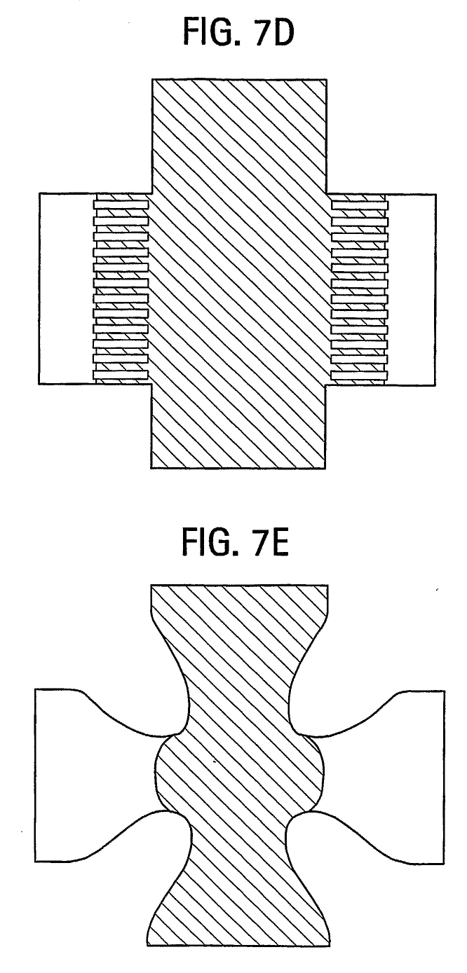

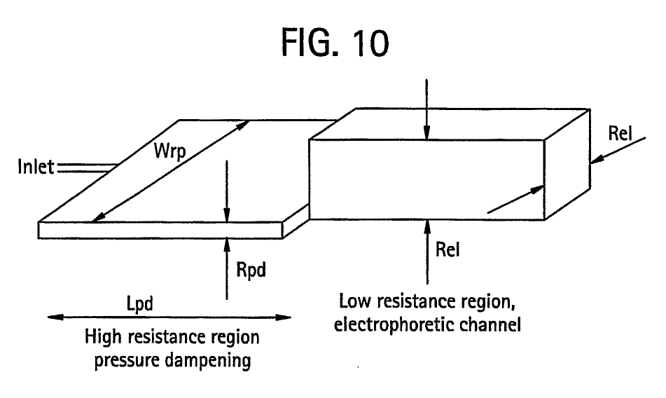

Additional methods for employing capillarity to introduce a gel into a channel are shown in FIGS. 7a-7e. FIGS. 10a-10c illustrate how a gelling material introduced into a single reservoir (7b) of a device (7a) may be constrained by capillarity (7c). FIG. 7d illustrates how partitions in channels prevent the gel from entering those channels, and FIG. 7e illustrates how a constriction in the channels prevents the gel from entering those channels.

Devices of the invention may be fabricated from any suitable material.

Exemplary materials include polymers such as poly(dimethylsiloxane) (PDMS), glass, and silicon. Methods for fabricating microfluidic devices are well known in the art, e.g., photolithography, rapid prototyping, silicon micromachining, and injection molding.

In addition to the sample introduction feature of the present invention, microfluidic devices may include channels and components for analysis, separation, isolation, and reaction of components in a sample.

An exemplary device of the invention is fabricated from PDMS and has channel dimensions of w=150 μm, h=17 μm, h/w˜1/10. Seven 10 μm partitions divide the channel into eight subchannels, each of 10 μm nominal width, which is smaller than the channel height (17 μm). Additionally, fabrication of >1 aspect ratio devices in PDMS gives sloping walls from overdevelopment or replication wear, yielding smaller subchannels.

Method

A device of the invention may be employed to introduce a plug of fluid, e.g., a sample plug, into a channel as follows. The sample is first pumped through a sample introduction channel into the intersection, e.g., via an applied electric field or pressure. Structures disposed in portions of the second channel, into which the sample will be introduced, introduce anisotropy to flow and prevent dispersion of the sample during loading. After sample is present in the intersection, a plug of sample having substantially the same shape as the intersection is introduced into the second channel, e.g., via an electric field or pressure gradient applied along the second channel. Once injected, the components of a sample may be analyzed, separated, isolated, reacted, or otherwise manipulated.

In one embodiment, the device contains two intersecting channels, where the four portions of channels connected by the intersection contain structures that introduce anisotropy, e.g., by subdividing the channel into subchannels, e.g., to alter the local electrical permeability. The structures may then be used in pairs during sample loading and introducing steps, i.e., the structures in the sample introduction channel are not important during sample loading but shape the plug of sample during introduction into a second channel. The structures together define the geometrical shape of the sample plug introduced into microfluidic channel. An exemplary device of this type is shown in FIG. 2a-2b. The use of fewer structures than channel portions intersecting may result in control of dispersion in fewer than all dimensions of a sample plug.

An example of a method of the invention is illustrated in FIG. 2c-2d. Injections were carried out by first drawing the sample electrokinetically from the sample (S) reservoir across the sample channel toward the sample waste (SW) while the potential of electrodes in buffer (B) and buffer waste (BW) reservoirs were “floated”, to achieve zero current. Floating the electrodes in both arms of the second channel allows an easy way to match the electrical fields at the intersection. This simple arrangement fills the entire channel intersection with sample. Comparing the sample distribution achieved in the loading step for IEF and the method described herein (FIGS. 2c and 2d), we observe the preferred rectangular concentration profile for the latter injection.

In an intersection lacking an adjacent structure that introduces anisotropy, the extent of mushrooming in the open intersection is hard to control and can lead to a dramatic spreading of the sample into the open separation channel, without focusing potentials applied in the separation channel (FIG. 1a). Isoelectric confinement, shown in FIG. 2d, reduces this problem, but at the cost of reduced amount of sample injected and an asymmetric, trapezoidal concentration profile of the sample plug.

IEF and the method of the invention both result in comparable width of the base of an injected sample plug, while the latter method also has an equal width at the top of the plug. In contrast, IEF results in a trapezoidal concentration profile of the sample plug, which contains less analyte than possible with the present method. The trapezoidal concentration profile will tend to spread axially to the length defined by is largest base. The resulting resolution, which decreases inversely with the sample bandwidth, will be no better than that of a rectangular concentration profile of equal axial extent. Sample introduction by the method described herein will contain more sample than IEF injection, without loss of resolution. Moreover, IEF injection requires application of pull-back potentials during a sample dispensing step to avoid sample trailing. The method of the invention does not require application of either focusing of or pull-back potentials to generate a discrete sample plug, making the instant method simpler to implement and permitting higher frequency of injection, e.g., at least 1, 10, 100, 1000, or 10,000 Hz (FIG. 5d). Pull-back potentials may, however, be employed with the invention.

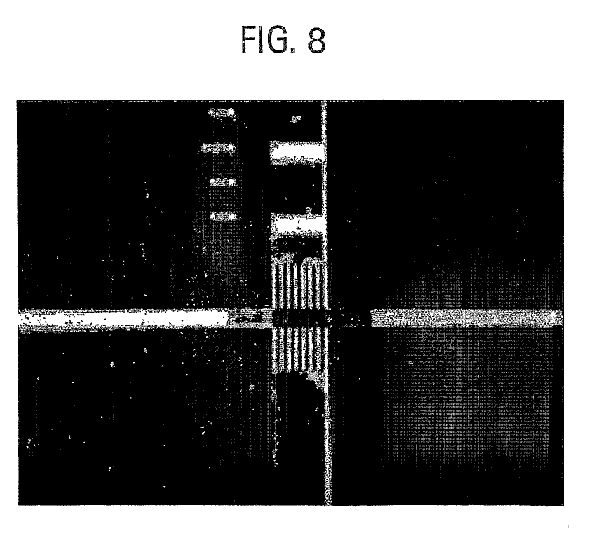

In one example, we used an intersection of a narrow sample introduction channel (30 μm) and wide separation channel (200 μm) to inject equimolar mixtures of fluorescein and carboxyfluorescein. The resulting separation (FIG. 8) shows well-separated rectangular zones of fluorescein and carboxyfluorescein. The tall separated zones have an aspect ratio of 4:1, combining axial resolution and greater in-plane pathlength. This separation of closely related molecules, which differ by a single charge, gives a resolution of 3.5. Additional separations employing devices of the invention are shown in FIGS. 5a-5c. A sample introduction and separation in the device of FIG. 3a is shown in FIG. 3b.

A device employing sheath flow is shown in FIG. 4b. This device is configured to allow electrokinetic pumping of sample and sheathing flows using a single pressure differential or potential difference. For example, a potential difference is created by placing electrodes in the SW reservoir and the B reservoir directly below the S reservoir in the figure. This arrangement may generate electroosmotic flow from the S reservoir and the two B reservoirs flanking the S reservoir through the channel intersection and towards the SW reservoir.

In another embodiment, the device contains a plurality of intersections having structures disposed adjacent thereto. Such systems would allow for manipulation of a single sample plug, or a series of sample plugs, such that multiple manipulations can be performed on a sample. For example, the sample may be subject to a one or more separations, e.g., that are based on different mechanisms, e.g., electrophoretic separation, isoelectric focusing, size-based separation, chromatographic separation, and affinity separation.

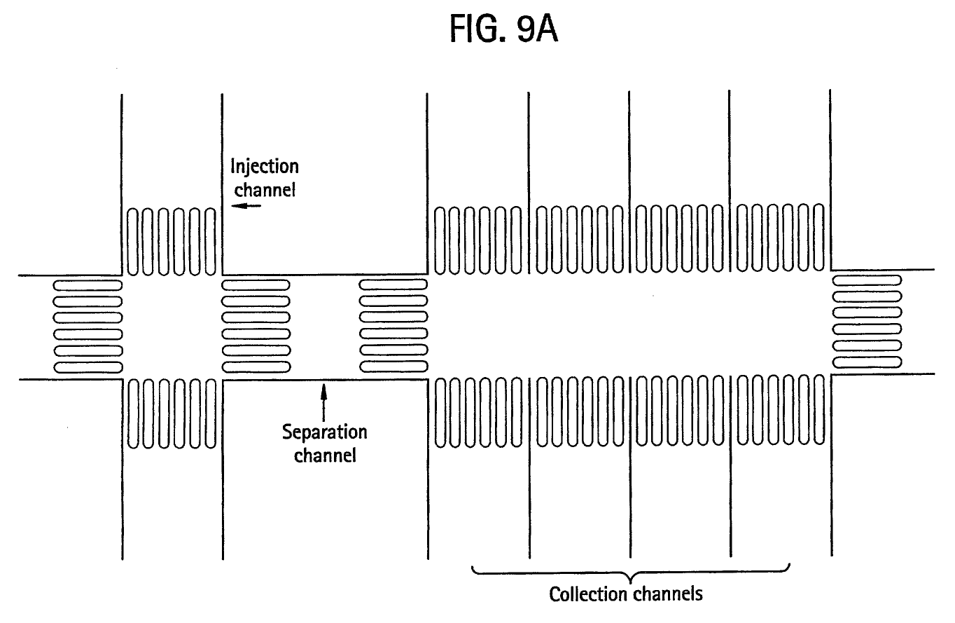

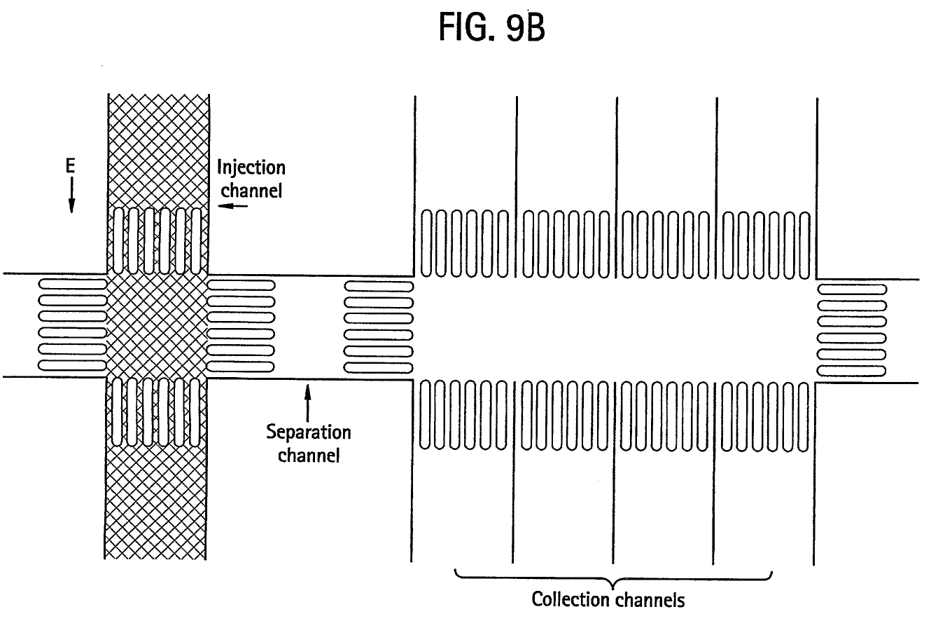

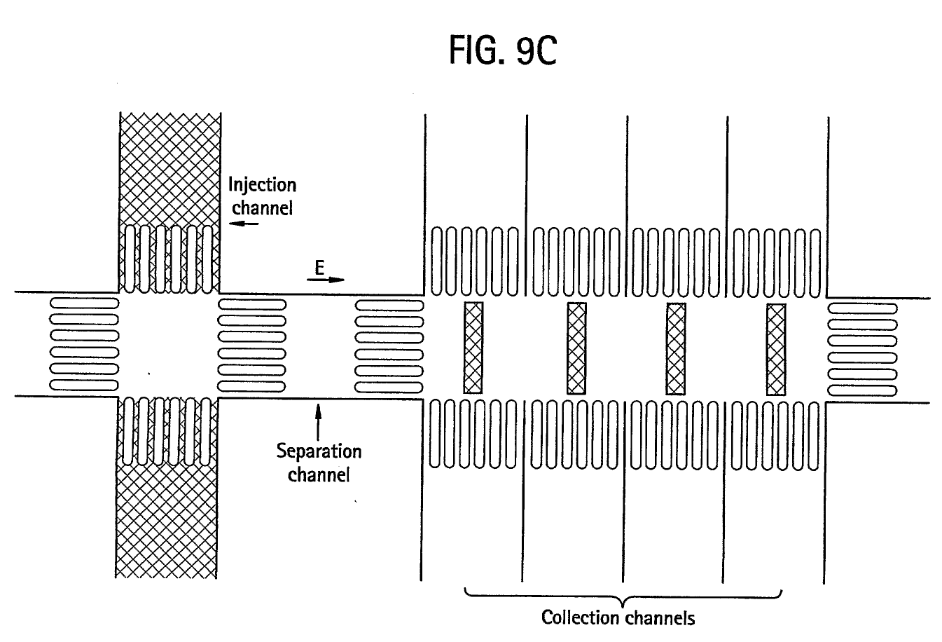

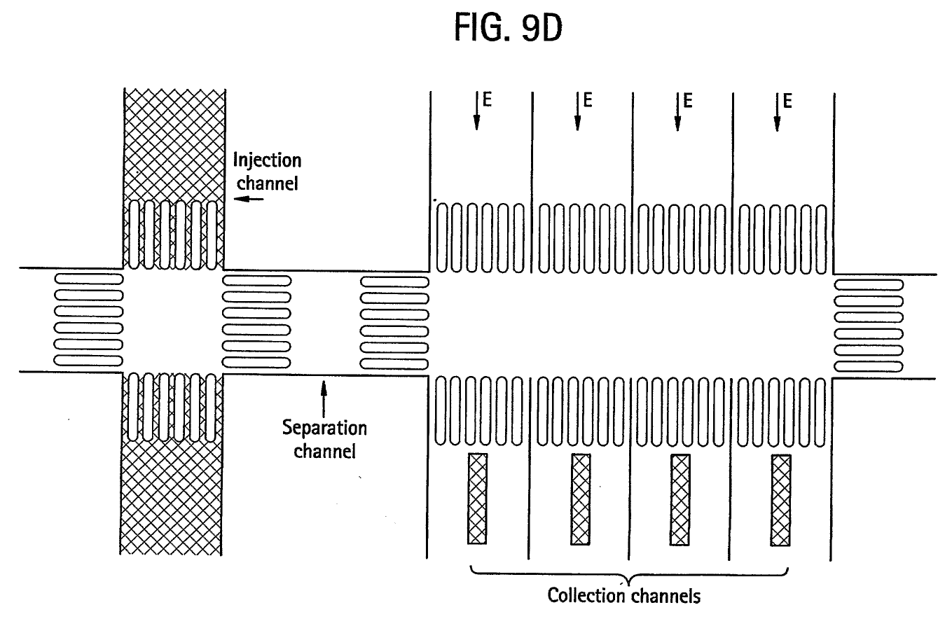

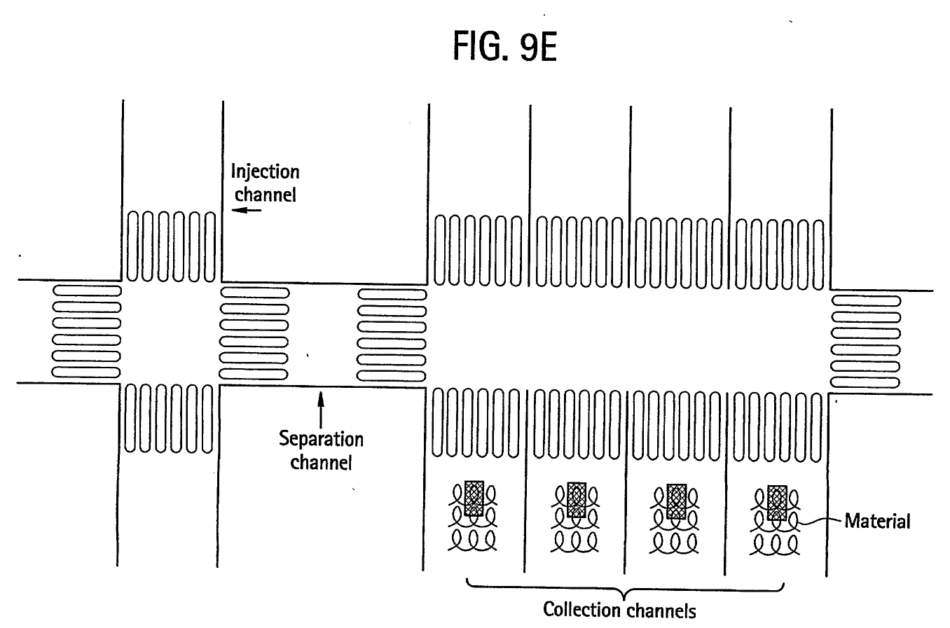

FIG. 9a shows a geometry in which structures that introduce anisotropy, e.g., structures that partition a channel into subchannels, can be used for sample manipulation. A plug is injected from the injection channel across and into the separation channel (FIG. 9b), as described above. The plug is then driven electrokinetically along the separation channel and is electrophoretically separated into distinct bands of analyte species (FIG. 9c). A series of collection channels are placed along the separation channel, each containing a structure, e.g., partitions, and with partitions in the separation channel itself. FIG. 9a shows four such collection channels, but any number can be constructed. Applying an electric field along the collection channels causes the separated bands to travel into the collection channels (FIG. 9d). As with injection, the structures in the collection channels shape the electric field lines so that each band is injected into the collection channel with minimal distortion. This process can be repeated many times, so that large quantities of separated material can be accumulated. The collection channel may include a solid phase for concentration, e.g., through charge or affinity based capture. Other concentration techniques, such as isotachophoresis, are known in the art.

Another application where a structure similar to that of FIG. 9a is useful is multi-dimensional electrophoresis. Presently, two-dimensional electrophoresis is used to separate complicated molecules like proteins. The basic idea is that a sample is separated in one direction, e.g., by electrophoresis. This results in a series of bands, where each band has, e.g., a different surface charge density. A separation is then performed in an orthogonal direction, on the bands that were previously separated. The second separation is typically designed to be sensitive to different molecular properties. Thus 2D electrophoresis results in a two-dimensional array of components separated from a sample. Using a device as in FIG. 9a, the first dimension of separation is performed as described above and in FIGS. 9b-9d, and the resulting bands are stored in collection channels. Once a sufficient quantity of each analyte has been separated and collected, a different separation can be performed in each collection channel. This would represent 2D electrophoresis. The process could be repeated N times, for N-dimensional separation. The advantage this technique has over conventional 2D electrophoresis is that each separation stage can be performed multiple times, so that each separated band becomes concentrated enough that the next dimension of separation can be detected. A material, e.g., a packed bed of beads or a gel plug, to which the separated molecules adsorb or bind may be placed in the collection channels (FIG. 9e). This material would allow the concentration of separated molecules to be enhanced; the molecules can be concentrated in the material and then released, e.g., by changing the solvent pH or salt concentration, for further manipulation.

The arrangement of collection channels and structures shown in FIG. 9a can also be used to inject multiple plugs of the same sample into a plurality of channels, e.g., for replicate analysis or for manipulation in a variety of ways.

In devices that employ gels, in addition to creating an anisotropy to flow, the gel may create an environment to localize or immobilized a cell, virus, or compound. Exemplary gels for use with biological systems include collagen containing gels such as Matrigel®. Particulate components may be localized in the gel by including them in the gel and then inducing gelation. Components, e.g., proteins, enzymes, drug candidates, and viruses, that are capable of passing through the pores of the gel may be introduced before or after gelation. Methods for attaching such components to gels, either covalently or non-covalently, are known in the art. Plugs of fluid may then be introduced into such a gel, e.g., for detection of a component in the plug or the gel and to determine a cellular or viral response to a component in the plug. The ability to control the size and shape of the plug introduced allows for precise delivery of a desired amount of a component.

Gels may also be employed as filters to prevent certain portions of a sample from being introduced into a device. For example, a gel may act as a size based filter to remove particulate matter from a sample. A gel may also contain groups that bind to or react with potential components of a sample to remove or reduce such components prior to a separation, analysis, reaction, or other manipulation. For example, a charged gel may be employed to remove components of the opposite charge, e.g., as in ion exchange. In another example, affinity reagents, e.g., magnetic particles, antibodies, receptors, and avidin/streptavidin, may be employed to bind components. Gels that contain localized or immobilized components may also allow products from reactions or degradations or such components (e.g., through cellular respiration or enzymatic action) to pass through for analysis or further manipulation.

### In-Channel Differential Resistance to Flow

The invention also features a device that exhibits in-channel differential resistance to pressure-driven flow. The device includes a structure in a channel that provides greater resistance to pressure-driven flow than other portions of the channel. Desirably, the structure increases the resistance to pressure-driven flow, without altering other the resistance of the channel to other forms of flow, e.g., those driven by electric fields.

Device

An exemplary device having in-channel differential resistance to pressure is shown in FIG. 10. Such devices that include a structure that provides a differential resistance to pressure-driven flow are based on the ability to increase the localized resistance to pressure-driven flow. For low Reynolds number flow, resistance to pressure driven flow is given largely by viscous dissipation:

$$Δ P = Q \frac{μ {L}_{pd}}{{R}_{pd}^{4}} ,$$

where ΔP is the pressure gradient, Q is the volumetric flow rate, μ is the dynamic viscosity, L is the length of the structure, R is the hydraulic radius or the smallest dimension in the channel cross-section, subscript PD stands for pressure dampening, EL for electrophoresis. With reference to FIG. 10, resistance to pressure-driven flow of the electrophoretic channel is much smaller than that of the dampening region, so, although there exists a ΔP across both channels, we can ignore the hydrodynamic resistance of the electrophoretic channel as well as the pressure drop across it.

The following calculation illustrates the phenomenon. For a 1 mm liquid column height difference at the sample inlets:

ΔP=ρgΔh=10³·10·10⁻³=10 Pa

The volumetric pressure-driven flow rate in the electrophoresis channel is given by the cross-sectional area times the linear flow rate, u. Desirably, u due to pressure-driven flow is much smaller that uₑₒ (from electroosmosis) and uₑₚ (from electrophoresis), ca. 10 μm/s.

$$Δ P = μ \cdot u \frac{{R}_{el}^{2} {L}_{pd}}{{R}_{pd}^{4}} = μ \cdot u \frac{{R}_{el}^{2}}{{R}_{pd}^{2}} \frac{{L}_{pd}}{{R}_{pd}^{2}}$$

For a typical device, Rₑₗ≈100 μm, R_{pd}≈10 μm, which gives:

$$Δ P = {10}^{- 3} \cdot {10}^{- 5} \cdot {10}^{2} \frac{{L}_{pd}}{{10}^{- 10}} = {10}^{4} {L}_{pd} ( m )$$

For ΔP=10 Pa; L_{pd}=10⁻³m, for comparison a typical separation channel length is on the order of ˜10⁻² m.

The structure in this device may result in Joule heating, as well as reduced field strength in the electrophoresis channel because of L_{pd}. For R_{pd}˜1-10 μm, this decrease in electrical field is tolerable. If the cross-sectional area of the PD region is smaller than that of the separation channel, there will be heat production given by P=IV=I²R, where electrical resistance scales linearly with the cross-section. A desirable structure will be a narrow channel of equal cross-section to a square cross-section separation channel. For example, the structure may have a height of at most 90, 75, 50, 25, 10, or 5% of the channel.

The device may be fabricated out of standard materials and methods, as described above. In addition, a structure that causes a parallel differential resistance to pressure may be included in a device including structures that provide perpendicular differential resistance, e.g., under an applied electric field or pressure-driven flow.

Method

The device of the invention, e.g., as shown in FIG. 10, may be employed to dampen pressure driven flow in a microfluidic device. The structure, as described above, is disposed between two fluid reservoirs, thereby minimizing secondary pressure-driven flow caused by unequal heights of columns of fluid in the reservoirs. The reduction of secondary flow is desirable in systems that employ sample loading or manipulation under applied electric fields, as described herein. This reduction in secondary flow is useful when loading sample into an intersection, e.g., as described herein, as the flow parameters may be controlled essentially only through applied electric fields. In addition, decoupling of pressure-driven flow from electrokinetic flows allows aspiration and replacement of a sample liquid with another one without disturbing an injected sample. This scheme allows multiple analytes to be sequentially injected using the same microchip.

### OTHER EMBODIMENTS

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the appended claims.

Other embodiments are in the claims.

What is claimed is:

1. A microfluidic device comprising:
a. a first channel;
b. a second channel that comprises a first structure that causes anisotropic flow; and
c. an intersection of said first and second channels, wherein said structure is disposed adjacent said intersection.

2. The device of claim 1, further comprising a second structure adjacent said intersection that causes anisotropic flow, wherein said intersection bifurcates said first and second channels, and said first and second structures are disposed on opposite sides of said intersection.

3. The device of claim 2, further comprising third and fourth structures adjacent said intersection, wherein said third and fourth structures cause anisotropic flow and are disposed on opposite sides of said intersection and in said first channel, and wherein said intersection is bounded by said first through fourth structures.

4. The device of claim 1, wherein said first structure lowers the electrical permeability of at least a portion of said second channel.

5. The device of claim 1, further comprising a voltage source capable of generating a voltage gradient spanning said intersection.

6. The device of claim 1, wherein said device comprises PDMS, glass, or silicon.

7. The device of claim 1, wherein said first structure divides said second channel into a plurality of subchannels.

8. The device of claim 1, wherein said first structure comprises a porous matrix.

9. The device of claim 8, wherein said porous matrix comprises a gel.

10. The device of claim 9, wherein said gel exhibits reverse thermal gelation.

11. The device of claim 8, wherein said gel is biocompatible.

12. The device of claim 11, further comprising cells dispersed in said gel.

13. The device of claim 1, wherein said first channel further comprises a differential resistance structure, wherein said first channel has a first resistance to pressure-driven flow in the absence of said differential resistance structure, and said differential resistance structure has a second resistance to pressure-driven flow that is higher than said first resistance.

14. The device of claim 1, wherein said anisotropic flow is produced by an electric field.

15. The device of claim 1, wherein said anisotropic flow is produced by hydrodynamic pressure.

16. The device of claim 1, further comprising third and fourth channels capable of producing a sheath flow adjacent to said first structure.

17. The device of claim 16, wherein said third and fourth channels are capable of introducing fluid into said first channel upstream of said intersection.

18. A method for introducing a sample in a microfluidic channel, said method comprising the steps of:
a. providing a microfluidic device of claim 1;
b. pumping said sample via said first channel into said intersection; and
c. pumping said sample in said intersection into said second channel.

19. The method of claim 18, further comprising allowing separation of at least two components in said sample introduced into said second channel.

20. The method of claim 18, further comprising analyzing, reacting, concentrating, or isolating at least a portion of said sample.

21. The method of claim 18, wherein in step (c) said sample is introduced into said second channel in a plug having substantially the shape of said intersection.

22. The method of claim 18, further comprising repeating steps (b) and (c) to introduce a plurality of plugs of sample into said second channel.

23. The method of claim 22, wherein said repeating occurs at a rate of at least 1, 10, 100, 1,000, or 10,000 Hz.

24. The method of claim 18, wherein said device further comprises a third channel that forms a second intersection with said second channel, wherein said third channel comprises a first structure that causes anisotropic flow under an applied electric field.

25. The method of claim 24, further comprising:
d. pumping at least a portion of said sample introduced into said second channel into said second intersection; and
e. introducing at least said portion of said sample into said third channel.

26. The method of claim 25, wherein said sample undergoes a first manipulation in said second channel and at least said portion of said sample undergoes a second manipulation in said second channel, wherein said first and second manipulations may be the same or different.

27. The method of claim 18, wherein said pumping in step (b) comprises applying an electric field to said first channel.

28. The method of claim 18, wherein said pumping in step (c) comprises applying an electric field to said second channel.

29. The method of claim 18, wherein said pumping in step (b) comprises applying a pressure differential to said first channel.

30. The method of claim 18, wherein said pumping in step (c) comprises applying a pressure differential to said second channel.

31. The method of claim 18, wherein said first structure comprises a gel.

32. The method of claim 31, wherein said gel comprises a localized component.

33. The method of claim 32, wherein said component comprises a cell, virus, enzyme, or drug candidate.

34. The method of claim 31, further comprising assaying said sample for interaction with said component.

35. A method of forming a gel in a microfluidic device, said method comprising the steps of:
a. providing a microfluidic device comprising a channel having a structure that divides a portion of said channel into subchannels;
b. introducing a liquid capable of gelling into said channel, wherein said liquid flows through said channel by capillary action to fill said subchannels substantially; and
c. allowing or causing said liquid to gel.

36. The method of claim 35, wherein said liquid comprises a cell, virus, enzyme, or drug candidate.

37. A microfluidic device comprising a channel comprising a structure, wherein said channel has a first resistance to pressure-driven flow in the absence of said structure, and said structure has a second resistance to pressure-driven flow that is higher than said first resistance.

38. The microfluidic device of claim 37, wherein said structure and said channel have substantially the same resistance to electric-field-driven flow.

39. The microfluidic device of claim 37, wherein said structure comprises a channel that is shorter and wider than said first channel in the absence of said structure.

40. The microfluidic device of claim 37, wherein said structure has a height of at most 10% of said channel in the absence of said structure.
